(19) United States
(12) Patent Application Publication
(10) Pub. No.: US 2004/0200313 A1
(43) Pub. Date: Oct. 14, 2004

(54) Torsion-vibration damper

(76) Inventors: Jurgen Kroll, Ulmengasse, DE (US); Norbert Bastel, Obernhausen (DE); Till Ebner, Pfung-stadt (DE)

Correspondence Address: BorgWarner, Inc., Powertrain Technical Center, Suite 100, 3800 Automation Avenue, Auburn Hills, MI, 48326, US

(21) Appl. No.: 10/413,078

(22) Filed: Apr. 14, 2003

(30) Foreign Application Priority Data
Apr. 12, 2003 (EP) 02008361.4

(51) Int. Cl. F16F 15/10

(52) U.S. Cl. 74/574

(57) ABSTRACT

A torsion-vibration absorber for use with a motor vehicle includes a transmission element at a driving end and a transmission element at a driven end adapted to be rotary deflected around an axis to the transmission element at the driving end. At least one compression spring connects the transmission element at the driven end with the transmission element at the driving end. At least one reinforcing component is encompassed by at least a portion of the at least one compression spring and includes a securing device to substantially limit displacement of the at least one reinforcing component in relation to the at least one compression spring.

### BACKGROUND OF THE INVENTION

1. Field of the Invention

The present invention relates, generally, to a torsion-vibration damper for use with a motor vehicle and, particularly, to a reinforcing component for such a torsion-vibration damper.

2. Description of the Related Art

It is well known that the powertrain of a motor vehicle becomes excited to torsional vibrations through torsional irregularity of the engine, caused by the ignition, of the vehicle. In particular, the frequency of the ignition at a certain speed of the engine corresponds to the so-called “natural frequency” of the powertrain, during which particularly large oscillation deflections occur, which can cause rattling noises of the gearbox and humming noises of the body of the vehicle. The rattling noises are a result of the gears and synchronizers knocking against each other in the gearbox, when they are subject to backlash and not in flux. The humming noises are a result of the fact that the vibrations are transmitted into the vehicle body partially also through the bedding of the gearbox block and the drive shaft. Noises of this type can be eliminated or at least reduced to a relatively large extent using a torsion-vibration damper because it enables an elastic torsion between the crankshaft and inlet shaft of the gearbox.

A number of embodiments of torsion-vibration dampers are generally well known in the related art. For example, published German patent applications DE 41 28 868 A1, DE 197 29 999 A1, and DE 199 58 813 A1 disclose various embodiments of a torsion-vibration damper. The primary components of a torsion-vibration damper generally include a transmission element at a driving end and a transmission element at a driven end. Both transmission elements are elastically connected with each other through one or more compression springs so that they can rotate against each other around an axis of rotation.

With torsion-vibration dampers, a problem generally occurs in that each compression spring, which elastically connects the transmission element at the driven end with the transmission element at the driving end, is curved radially outward over its length at relatively higher speed due to centrifugal forces. In the case of increasing upsetting deformation of the compression spring, the coil thereof adjacent the free end of an assigned radial support in the pressure direction rests on this radial support. In this case, the compression spring is restrained by the radial support in a further movement effect. Thus, the torque causing the deformation of the compression spring cannot be transferred by this coil to any of the coils remaining radially within the radial support. Ultimately, the individual compression springs are suspended to loads. As a consequence, the deformation path of the compression spring may be shortened for the portion of such remaining coils that lie slightly beyond the predetermined limiting values of such remaining coils.

Various measures used to address this problem are well known in the related art. For example, published German application DE 197 29 999 A1 discloses the use of so-called “reinforcing components” inserted radially within the cylindrical inner wall of the compression spring. The reinforcing components may be of the type having elongated cylindrical pins that prevent the deflection of the compression spring due to centrifugal forces.

Published German application DE 197 29 999 A1 discloses a torsion-vibration damper in which two compression springs coaxially fitting into one another encompass a reinforcing component. Similarly, published German application DE 197 29 999 A1 discloses a torsion-vibration damper in which the compression springs are arranged between faces of stopper shoes and/or guide shoes. However, while the torsion-vibration dampers of the related art have generally worked for their intended purposes, they still suffer from the disadvantage that rattling noises occur even with these measures.

Thus, there remains a need in the art for a torsion-vibration damper that eliminates rattling noises or at least noticeably reduces the volume of them.

### SUMMARY OF THE INVENTION

The present invention overcomes the disadvantages in the related art in a torsion-vibration damper for use with a motor vehicle that includes a transmission element at a driving end and a transmission element at a driven end adapted to be rotary deflected around an axis to the transmission element at the driving end. At least one compression spring connects the transmission element at the driven end with the transmission element at the driving end. At least one reinforcing component is encompassed by at least a portion of the at least one compression spring and includes a securing device to substantially limit displacement of the at least one reinforcing component in relation to the at least one compression spring.

One advantage of the torsion-vibration damper of the present invention is that neither the compression spring(s) nor the reinforcing component(s) can move randomly within a housing of the torsion-vibration damper surrounding them.

Another advantage of the torsion-vibration damper of the present invention is that rattling noises caused by contact between the compression spring(s) and the reinforcing component(s) at the case as well as at the transmission elements are avoided.

Another advantage of the torsion-vibration damper of the present invention is that it avoids the compression spring(s) being suspended to high mechanical loads, which could lead to breakage of the compression spring(s).

Other objects, features, and advantages of the present invention will be readily appreciated as the same becomes better understood while reading the subsequent description taken in conjunction with the accompanying drawings.

### BRIEF DESCRIPTION OF THE DRAWINGS

FIG. 1a is a partial side view of a torsion-vibration damper of the present invention in the unloaded condition showing the synthetic block pin with the spring plate thereof.

FIG. 1b is an enlarged cross-section of a torsion-vibration damper of the present invention in the loaded condition showing the synthetic block pin with the spring plate thereof.

FIG. 2 is a side view of a first embodiment of the block pin with the spring plate of a torsion-vibration damper of the present invention.

FIG. 3 is a side view of a second embodiment of the block pin with the spring plate of a torsion-vibration damper of the present invention.

FIG. 4 is a side view of a third embodiment of the block pin with the spring plate of a torsion-vibration damper of the present invention.

FIG. 5 is a side view of a fourth embodiment of the block pin with the spring plate of a torsion-vibration damper of the present invention.

FIG. 6 is a side view of a fifth embodiment of the block pin with the spring plate of a torsion-vibration damper of the present invention.

FIG. 7 is a side view of a sixth embodiment of the block pin with the spring plate of a torsion-vibration damper of the present invention.

### DETAILED DESCRIPTION OF THE INVENTION

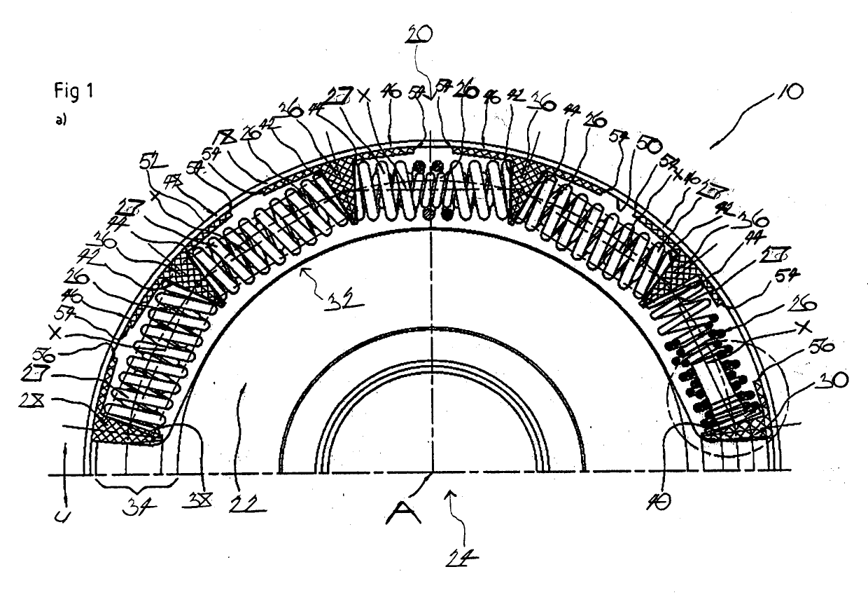

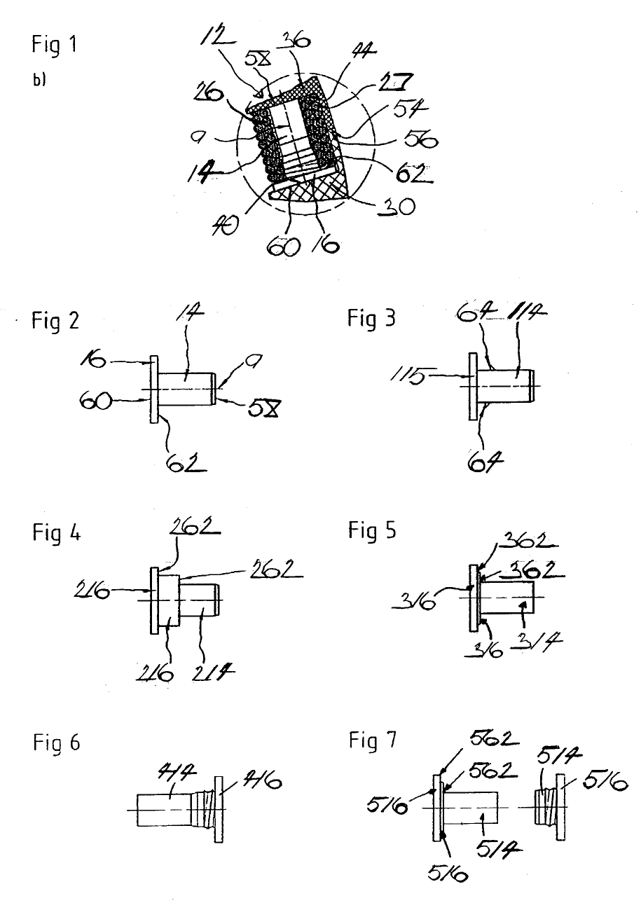

Referring now to the figures, where like numerals are used to designate like structure, a torsion-vibration damper is generally indicated at 10 in FIG. 1a. As shown in FIGS. 1a and 1b, the torsion-vibration absorber 10 has at least one reinforcing component, generally indicated at 12, in the form of a block pin 14 with a spring plate 16, which will be described in detail below. The torsion-vibration absorber 10 is designed as a two-mass flywheel. As shown in FIG. 1a, a first mass 18 is designed as a transmission element 18 at the driving end, generally indicated at 20, and a second mass 22 is designed as a transmission element at the driven end, generally indicated at 24. The transmission element 22 at the driven end 24 and the transmission element 18 at the driving end 20 can be rotary deflected relative to each other around an axis of rotation “A.” Both transmission elements 18, 22 are connected to each other by energy-storage devices 26 in the form of at least one compression spring 26.

In a preferred embodiment of the torsion-vibration damper 10 and as shown in FIG. 1a, a plurality of compression springs 26 are admitted through triggering components such as stopper shoes 28, 30 provided at each of the transmission elements 18, 22. In the preferred embodiment, the torsion-vibration damper 10 includes two stopper shoes 28, 30. One of the stopper shoes 28, 30 is secured against torsion to the transmission element 18, and the other of the stopper shoes 28, 30 is secured against torsion to the transmission element 22. Between the stopper shoes 28, 30 are five spring stages, generally indicated at 32, aligned successively one behind another in a channel 34 running concentric to the axis of rotation “A” and forming a series of spaced spring-stage connections 36 by guide shoes 36. Each spring stage 32 consists of two compression springs 26, 27. One of the compression springs 26 is inserted into the other of the compression springs 27 in parallel-switched manner.

The spring stages 32 following the stopper shoes 28, 30 are supported on a side of one end against corresponding faces 38, 40 of the stopper shoes 28, 30 and on a side of the other end against corresponding faces 42, 44 of the guide shoes 36.

While the stopper shoes 28, 30 are secured against torsion with the transmission elements 18, 22, the guide shoes 36, with their respective external walls 46, are movably guided at the ring 48 of the cylindrical inner wall 50. The ring 48 is a component of the transmission element 18 at the driving end 20 and arranged radially outside the spring stages 32, concentrically to the axis of rotation “A.” The stopper shoes 28, 30 as well as the guide shoes 36 extend in the circumferential direction “u” of an outer wall 52 facing the inner wall 50 of the ring 48. Extensions of the guide shoes 36 guide the guide shoes 36 on the ring 48 and reduce surface pressure toward the inner wall 50 of the ring 48. In addition, free ends 54 of the guide shoes 36 can serve together with free ends 56 of the stopper shoes 28, 30 as torsion-angle stops for avoidance of a Ausblockens of the spring stages 32 and/or prevention of complete compression of the compression springs 26.

For prevention of deformations of the compression springs 26, 27 of the spring stages 32 caused by centrifugal forces, the two compression springs 26, 27 of a spring stage 32 encompass the reinforcing component 12 that is in the form of the block pin 14. The block pin 14 is substantially cylindrical and is received within the spring stage 32 such that the block pin 14 is encompassed by the two compression springs 26, 27 of a respective spring stage 32 such that the symmetry axis “a,” shown in FIGS. 1b and 2, coincides essentially with the spring axes “x,” shown in FIG. 1a, of the compression springs 26 of the respective spring stages 32. In the preferred embodiment, the block pin 14 is manufactured from a synthetic material.

If one or more of the spring stages 32 switched into series have a lower spring rate than the other spring stages 32, this can lead to an overload of the compression springs 26, 27 of the corresponding spring stages 32 during very high torques being transferred. Loads that amount to a multiple of the block force of the compression springs 26 frequently cause a destruction of these compression springs 26. To prevent such a destruction, extensions are provided beside the guide shoes 36 and stopper shoes 28, 30. The length of the block pins 14 is chosen such that, before achieving the maximally permissible block force of the compression springs 26, the block pins 14 come to a stop at the front side 58, 60, as shown in FIG. 1b, against the respective faces 42, 44 of the guide shoes 36 and/or stopper shoes 28, 30. In this way, the block pins 14 operate to limit compression. The transferred block force is distributed through the block pin 14, stopper shoes 28, 30, and guide shoes 36 such that the overall system is stabilized.

To prevent noise that could be generated by a backward and forward movement of the block pin 14, as shown in FIGS. 1b and 2, the spring plate 16 is defined at one end of the front side 60 of the block pin 14. The block pin 14 has a spring seat 62 on which each of the compression springs 26 is supported at a side of one end thereof. The spring plate 16 is preferably formed as one piece with the block pin 14. However, the spring plate 16 is at least axially non-movable in relation to the block pin 14.

Referring now to FIGS. 3-7, other embodiments of the reinforcing component are shown, where like numerals increased by 100 in each successive embodiment are used to designate structure like that of the reinforcing component 12 shown in FIG. 2. To secure the shorter, inner compression springs 26 compared to the longer, outer compression springs 27 (in the released condition)—against a noise-producing back and forward movement, the inner compression springs 26 are fixed directly to the block pin 114. The inner compression spring 26 may be fixed to the block pin 114 in many ways, including screwing, gluing, fitting, snapping, and locating with an additional fixing component (e.g., with connection plates). In addition to a spring plate 116 for locating an inner compression spring 26, the block pin 114 can include radially protruding cams 64, as shown in FIG. 3, onto which the inner compression spring 26 is snapped.

Differences in length as well as differences in the solid length of the compression springs 26 can also be compensated. As such and as shown in FIG. 4, several spring plates 216 spaced from each other in the axial direction are provided at the block pin 214, on which at least one of the compression springs 26, coaxially fitting into one another, can be supported on a side of one end thereof. Alternatively and in contrast to an outside spring plate 16 that has a comparatively larger outside diameter, the block pin 214 may have a further inside spring plate 216 with a comparatively smaller outside diameter and shifted in the axial direction to the center. The outer compression spring 27 can be supported on the spring seat 262 of the outside spring plate 216 on a side of one end thereof. The inner compression spring 26 can be supported on the spring seat 262 of the inside spring plate 216 on a side of one end thereof

Alternate embodiments of the block pin and spring plate are illustrated in FIGS. 5-7 where like numerals successively increased by 100 with respect to the alternate embodiment illustrated in FIG. 3 are used to designate like structure. Thus, each block pin 314, 414, and 514 includes an associated spring plate 316, 416 and 516 as well as spring seat 362, 462, and 562. As can be easily seen from inspecting these figures, the block pins 14, 114, 214, 314, 414, and 514 can extend for different lengths within an associated pair of compression springs 26, 27. Similarly, the spring seats 62, 162, 262, 362, 462, and 562 may be spaced in different increments in the axial direction.

The block pin 14, 114, 214, 314, 414, and 514 as well as their associated spring plates 16, 116, 216, 316, 416, and 516 of the reinforcing component are made ideally from high-strength, high-tech synthetic polyamide with a glass-fiber portion of about 50%. The polyamide is oil- and heat-resistant and can be manufactured economically as an injection-molded part.

As can easily be seen, the block pins 14, 114, 214, 314, 414, and 514 arranged within the respective compression springs 26, 27 include securing devices that limit the displacement of the reinforcing components block pins 14, 114, 214, 314, 414, and 514 in relation to the compression springs 26, 27 surrounding them. Consequently, neither the compression springs 26, 27 nor the reinforcing components can move randomly within the housing of the torsion-vibration absorber 10 surrounding them. Knocking of the compression springs 26, 27 and the reinforcing components at the case as well as at the transmission elements 18, 22, which causes rattling noise, is thereby avoided. Also, the torsion-vibration absorber 10 avoids the compression spring 26, 27 being suspended to high mechanical loads, which could lead to breakage of the compression spring 26, 27.

The present invention has been described in an illustrative manner. It is to be understood that the terminology that has been used is intended to be in the nature of words of description rather than of limitation. Many modifications and variations of the present invention are possible in light of the above teachings. Therefore, within the scope of the appended claims, the present invention may be practiced other than as specifically described.

What is claimed is:

1. A torsion-vibration damper for use with a motor vehicle comprising:
a transmission element at a driving end;
a transmission element at a driven end adapted to be rotary deflected around an axis to said transmission element at said driving end;
at least one compression spring connecting said transmission element at said driven end with said transmission element at said driving end; and
at least one reinforcing component being encompassed by at least a portion of said at least one compression spring and including a securing device to substantially limit displacement of said at least one reinforcing component in relation to said at least one compression spring.

2. A torsion-vibration damper as set forth in claim 1, wherein said securing device includes at least one spring plate supported by said at least one reinforcing component and on which said at least one compression spring is adapted to be supported.

3. A torsion-vibration damper as set forth in claim 2, wherein said at least one compression spring is adapted to be supported on a side of one end of said securing device.

4. A torsion-vibration damper as set forth in claim 1, wherein the length of said at least one reinforcing component substantially prevents complete compression of said at least one compression spring.

5. A torsion-vibration damper as set forth in claim 4, wherein the length of said at least one reinforcing component is greater than the maximum possible compression of said at least one compression spring such that said at least one reinforcing component is dimensionally stable.

6. A torsion-vibration damper as set forth in claim 1, wherein said at least one reinforcing component includes at least two reinforcing components and where a portion of said at least one compression spring encompasses said at least two reinforcing components.

7. A torsion-vibration damper as set forth in claim 6, wherein the at least a portion of the length of said at least one compression spring encompasses said at least two reinforcing components.

8. A torsion-vibration damper as set forth in claim 7, wherein one of said at least two reinforcing components is arranged behind the other one of said at least two reinforcing components in the axial direction and each of which supports on a side of one end thereof at least one spring plate, said at least one compression spring adapted to be supported on a side of one end of said at least one spring plate of one of said at least two reinforcing components and adapted to be supported on the other side of said one end of said at least one spring plate of the other one of said at least two reinforcing components.

9. A torsion-vibration damper as set forth in claim 8, wherein the sum of the lengths of said at least two reinforcing components substantially prevents a complete compression of said at least one compression spring.

10. A torsion-vibration damper as set forth in claim 1, wherein said securing device includes a locating unit for locating at least one of said at least one compression springs at said at least one reinforcing component.

11. A torsion-vibration damper as set forth in claim 10, wherein said locating unit is adapted to be fixed onto said securing device.

12. A torsion-vibration damper as set forth in claim 11, wherein said locating unit is adapted to be fixed onto said securing device by any of the methods consisting of screwing, gluing, fitting, pressing, and latching.

13. A torsion-vibration damper as set forth in claim 12, wherein said locating unit includes at least one of at least one connection plate and at least one cam arranged radially distal said at least one reinforcing component.

14. A torsion-vibration damper as set forth in claim 1, wherein said at least one compression spring includes at least two compression springs, said at least two compression springs coaxially fitted into one another and encompassing said at least one reinforcing component, and said securing device including at least two spring plates supported by said at least one reinforcing component and located axially distally and on each of which said at least two compression springs are adapted to be supported.

15. A torsion-vibration damper as set forth in claim 14, wherein said at least two compression springs are adapted to be supported on a side of one end of each of said at least two spring plates.

16. A torsion-vibration damper as set forth in claim 1, wherein said at least one reinforcing component is made from polyamide.

17. A torsion-vibration damper as set forth in claim 16, wherein said polyamide has a glass-fiber portion of about 50%.

18. A torsion-vibration damper as set forth in claim 1, wherein said at least one reinforcing component is injection-molded.

19. A torsion-vibration damper as set forth in claim 1, wherein said at least one compression spring is arranged between the faces of at least one of stopper shoes and guide shoes, said at least one reinforcing component being secured against displacement in relation to one of said faces.

20. A torsion-vibration damper as set forth in claim 19, wherein said at least one reinforcing component is integral with said at least one of stopper shoes and guide shoes.
